(19) United States
(12) Patent Application Publication
(10) Pub. No.: US 2007/0109322 A1
(43) Pub. Date: May 17, 2007

(54) Print control program product

(75) Inventor: Yuji Miyata, Kitanagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/598,724

(22) Filed: Nov. 14, 2006

(30) Foreign Application Priority Data
Nov. 14, 2005 (JP) 2005-329240

(51) Int. Cl. G09G 5/00

(52) U.S. Cl. 345/619

(57) ABSTRACT

A print control program product comprises storing an image data of a rendering object displayed in a preview image as a dot data in which a range containing at least the rendering object is represented in a dot arrangement, generating a tag information for distinguishing a portion corresponding to the rendering object within the dot data from the other portion, if the dot data contains a portion other than the rendering object, storing the tag information in association with the dot data. The redisplaying step includes displaying the rendering object after editing based on the dot data, and extracting and displaying a portion of the rendering object from the dot data in accordance with the associated tag information if the tag information corresponding to the dot data is stored at the tag information storing step.

### CROSS-REFERENCE TO RELATED APPLICATION

This application claims priority from Japanese Patent Application No. 2005-329240, filed on Nov. 14, 2006, the entire subject matter of which is incorporated herein by reference.

### TECHNICAL FIELD

Aspects of the present invention relate to a print control program product which displays a preview image that visualizes a printing result before printing on a printing apparatus, and more particularly to a print control program product which displays the preview image after editing promptly and correctly.

### BACKGROUND

When print data created by a personal computer (hereinafter simply referred to as a “PC”) is to be printed using a printer, it is common that a print instruction is sent from the PC to the printer to produce a printing result. To meet the needs of grasping the printing result before printing, there is a preview function of displaying the printing result of the printer on a monitor of the PC, before outputting the print data (print instruction) to the printer. This preview function is provided in an application program or a printer driver.

The preview function of the application program involves generating and displaying the preview image using font information set in an operating system of the PC and an image formation program in the application program. The displayed preview image may be often different from the printing result on the printer. This is because the font information provided for the PC and the font information built in the printer may be different, or the processing contents of creating the image data in the print data may be different.

The printer driver intervenes between the application program and the printer and assists in sending or receiving data therebetween. The print data generated by the application program is converted into a data format according to the printer, which is an output destination, and outputted to the printer by the printer driver. Thereby, the print data outputted from the PC is printed by the printer. Since the printer driver is a program prepared for the printer, the preview image displayed with this preview function can accurately reflect the actual printing result.

In recent years, the preview function of such a printer driver is enabled to make an edit process for the preview image. In this printer driver, the displayed preview image can be edited based on an instruction on the display screen. The edit process to be performed involves changing (moving) the display position of a displayed object, scaling up or down and deleting the object (see JP-A-2001-282499).

### SUMMARY

When the preview image is edited, it is necessary to redisplay the preview image after editing. Two redisplay methods have been proposed. The first method includes saving a rendering instruction of each object (constituting the preview image) displayed in the preview image, and rendering each object again in accordance with the saved rendering instruction, when the preview image after editing is displayed. The second method involves generating and storing the bitmapped data rendering each object displayed in the preview image and reconfiguring the preview image using the bitmapped data in making the redisplay.

With the first method, it is required to render each object in accordance with the rendering instruction every time of redisplay. Therefore, the display operation of the preview image is slow. Also, with the second method, since each object is stored in the bitmapped data, some portion of the earlier displayed object, which should be displayed, maybe hidden with the bitmapped data of the later displayed object, if the rendering areas of the objects overlap. The bitmapped data is formed in a rectangular range containing the object. If the object is not rectangular, a margin portion generated by the solid image is contained, in addition to the object. This results in the above-described phenomenon.

Aspects of the invention provide a print control program product that can display the preview image after editing promptly and correctly.

### BRIEF DESCRIPTION OF THE DRAWINGS

FIG. 1 is a block diagram showing the electrical configuration of a personal computer mounting a printer driver according to an aspect of the present invention;

FIG. 2 is a view schematically showing the configuration of a rendering instruction;

FIGS. 3A and 3B are views schematically showing the configuration of a preview management memory;

FIGS. 4A and 4B are views showing bitmapped data created based on the rendering instruction;

FIGS. 5A to 5D are views showing a preview image firstly displayed on an LCD when the preview image is requested to display and its production process;

FIGS. 6A to 6C are views showing the image in generating the bit map of an object with a mask set;

FIG. 7 is a view showing the preview image after the preview image of FIG. 5 is edited;

FIG. 8 is a flowchart of a preview process that is performed when the printer driver is started;

FIG. 9 is a flowchart of a bit map generation process that is performed in the preview process of FIG. 8;

FIG. 10 is a flowchart of a mask generation process that is performed in the bit map generation process of FIG. 9;

FIG. 11 is a flowchart of a preview screen generation process that is performed in the preview process of FIG. 8; and

FIG. 12 is a flowchart of a rendering process that is performed in the preview screen generation process of FIG. 11.

### DETAILED DESCRIPTION

<General Overview>

According to a first aspect of the invention, there is provided a print control program product comprising: software instructions which, when executed on a computer, enables the computer to perform predetermined operations; and a computer readable medium which stores the software instructions; the predetermined operations including: outputting a print data to a printing apparatus to enable the printing apparatus to print an image corresponding to the print data; displaying a preview image that visualizes the printing result on a display device before the outputted print data is printed; editing a rendering object displayed in the preview image based on a change instruction for the preview image displayed on the display device; and redisplaying the edited preview image, wherein, before the displaying step, the predetermined operations further include: storing the image data of the rendering object displayed in the preview image as a dot data in which a range containing at least the rendering object is represented in a dot arrangement; generating a tag information for distinguishing a portion corresponding to the rendering object within the dot data from the other portion, if the dot data contains a portion other than the rendering object; and storing the tag information in association with the dot data, and wherein the redisplaying step includes: displaying the rendering object after editing based on the dot data stored at the image data storing step; and extracting and displaying a portion of the rendering object from the dot data in accordance with the associated tag information, if the tag information corresponding to the dot data is stored at the tag information storing step.

According to a second aspect of the invention, the print control program product further comprises: acquiring a rendering information including at least one of an outside shape information indicating the outside shape of the rendering object, a representation information for representing a form of the rendering object, and a rendering area information indicating a rendering area, the rendering information being the information for defining the rendering object and set for each rendering object, wherein the displaying step includes rendering the rendering object in accordance with the representation information and the rendering area information of the rendering information acquired at the acquisition step, and wherein the image data storage step stores the dot data containing the rendering data of the rendering object rendered at the rendering step.

According to a third aspect of the invention, the print control program product further comprises: judging whether or not to generate the tag information corresponding to the rendering object, based on the rendering information of the rendering object, wherein the tag information generating step generates the tag information for the dot data, if the tag generation judgement step judges to generate the tag information for the dot data.

According to a fourth aspect of the invention, the image data storing step includes: storing the rectangular rendering data directly as the dot data, if the outside shape of the rendering object is rectangular in accordance with the outside shape information; and storing the dot data in a rectangular range including the rendering data of the rendering object rendered at the rendering step and additionally its peripheral portion, if the outside shape of the rendering object is not rectangular in accordance with the outside shape information, and the judging step judges to generate the tag information, if the outside shape of the rendering object is not rectangular.

According to a fifth aspect of the invention, the judging step judges not to generate the tag information, if the outside shape of the rendering object is rectangular.

According to a sixth aspect of the invention, the judging step judges to generate the tag information, if the rendering information acquired at the acquisition step is not a character rendering information, and the dot data storing step includes storing the character rendering data rendered at the rendering step directly as the dot data.

According to a seventh aspect of the invention, the judging step judges not to generate the tag information, if the rendering information is the character rendering information.

According to an eighth aspect of the invention, the print control program product further comprises: extracting a common area between the mask area information indicating a mask area contained in a mask information and the rendering area information, if the rendering information has the mask information indicating that at least part of the rendering object is masked, wherein, if the extracted common area is rectangular, the dot data storing step stores the rendering data of a portion corresponding to the common area as the dot data.

According to a ninth aspect of the invention, the print control program product further comprises: a specific information storage step of storing, for each the rendering object, the tag presence information indicating that the tag information corresponding to the dot data is stored, the dot specific information specifying the dot data, and the tag specific information specifying the tag information, wherein, when the rendering object is redisplayed, the redisplaying step specifies and displays one dot data corresponding to the rendering object with the stored dot specific information, when the rendering object is redisplayed, and wherein, if the tag presence information is stored corresponding to the dot specific information, the redisplaying step specifies one tag information with the corresponding tag specific information and extracts and displays a portion of the rendering object from the dot data based on the specified tag information.

According to a tenth aspect of the invention, a rendering order and a rendering area information of the rendering object are changeable based on a change instruction, the editing step includes editing the rendering object displayed in the preview image by updating the rendering order or the rendering area information based on the change instruction, the redisplay step includes displaying the corresponding rendering object in the dot data in accordance with the rendering order or the rendering area information after update, and the initial values of the dot data are held, irrespective of whether or not at least one of the corresponding rendering order and the corresponding rendering area information is updated.

With the print control program product according to the first aspect of the invention, at the dot data storing step, the image data of the rendering object displayed in the preview image is stored in the dot data in which a range containing at least the rendering object is represented in a dot arrangement. At the generating step, the tag information for distinguishing a portion corresponding to the rendering object of the dot data from the other portion is generated, if the dot data contains a portion other than the rendering object. And at the tag information storing step, the generated tag information is stored in association with the dot data. At the redisplaying step, the rendering object after editing is displayed based on the dot data stored at the dot data storing step. However, a portion of the rendering object is extracted and displayed from the dot data in accordance with the tag information, if the tag information corresponding to the dot data is stored.

Hence, the redisplayed preview image can be formed based on the stored dot data. That is, since the rendering object can be displayed by the dot data that is already stored, it is unnecessary to decode the rendering instruction of each rendering object to render (display) each rendering object, whereby there is the effect that the preview image can be redisplayed promptly.

Moreover, since a portion of the rendering object in the dot data is extracted from the dot data in accordance with the tag information and displayed, only the rendering object can be displayed, even if the dot data contains any other portion than the rendering object. In other words, even if the preview image is redisplayed based on the dot data, no other portion than the rendering object is displayed. Thereby, it is possible to avoid a situation where the earlier displayed rendering object (all or a part of rendering object) is hidden because any other portion than the rendering object in the dot data of the rendering object overlaps the earlier displayed rendering object, whereby there is the effect that each rendering object can be displayed accurately, even if each rendering object is displayed based on the dot data to form the preview image.

With the print control program product according to the second aspect of the invention, at the acquiring step, the rendering information having at least the outside shape information, the representation information and the rendering area information is acquired. At the rendering step, the rendering object is rendered in accordance with the rendering information (representation information and the rendering area information) acquired at the acquiring step. And at the dot data storing step, the dot data containing the rendering data of the rendering object rendered at the rendering step is stored.

When the preview image is displayed on the display device at the displaying step, it is necessary to generate the rendering data of the rendering object by making the dot expansion of the rendering information. That is, in displaying the preview image, the generation of the rendering data at the rendering step is requisite. Hence, by storing the dot data based on the rendering data generated at the rendering step, the dot data can be acquired as the image data of each rendering object before editing the preview image, whereby there is the effect that the redisplay of the preview image can be performed promptly and smoothly. Since it is unnecessary to create the dot data by making the dot expansion of the rendering information every time of redisplaying the preview image, it is possible to avoid the redundant process regarding the preview display as a whole.

With the print control program product according to the third aspect of the invention, at the judging step, it is judged whether or not it is unnecessary to generate the tag information corresponding to the rendering object, based on the rendering information of the rendering object, and the generation of the tag information at the generating step is not performed, if it is judged that it is unnecessary to generate the tag information for the dot data. Hence, there is the effect that it is possible to avoid a squeeze on the memory area due to storage of the unnecessary tag information by avoiding generating the tag information wastefully, and to speed up the redisplay process for the preview image than where the tag information is uniquely generated irrespective of the contents of the rendering object.

With the print control program product according to the forth and fifth aspects of the invention, at the dot data storing step, the rectangular rendering data rendered at the rendering step is stored directly as the dot data, if it is revealed that the outside shape of the rendering object is rectangular in accordance with the outside shape information acquired at the acquiring step. Also, at the dot data storing step, the dot data is stored in a rectangular range including the rendering data of the rendering object rendered at the rendering step and additionally its peripheral portion, if it is revealed that the outside shape of the rendering object is not rectangular in accordance with the outside shape information. And at the judging step, it is judged that it is unnecessary to generate the tag information, if the outside shape of the rendering object is rectangular. Therefore, the generation of the tag information at the generating step is performed if the outside shape of the rendering object is not rectangular. Hence, if the dot data of the stored range is coincident with the rendering data, the generation of the tag information may not be performed, because the dot data does not contain any other portion than the rendering object, whereas if not coincident, the tag information can be generated, because the dot data contains any other portion than the rendering object. That is, there is the effect that it is possible to accurately switch between the generation and the non-generation of the tag information depending on whether the tag information is necessary or not.

One of the typical dot data forms is the bitmap format. In this bitmap format, the dot data is generated in the rectangular range. Accordingly, the bitmapped data is composed of the rendering object only or contains the margin portion other than the rendering object, depending on whether or not the rendering object is rectangular. Therefore, there is the effect that in this program for creating the tag information depending on whether or not the shape is rectangular, the universal apparatus for generating the dot data in the bitmap format can be widely applied.

With the print control program product according to the sixth and seventh aspects of the invention, at the judging step, it is judged that it is unnecessary to generate the tag information, if the rendering information acquired at the acquiring step is the character rendering information, whereby the character rendering data rendered at the rendering step is stored directly as the dot data at the dot data storing step. Therefore, the generation of the tag information at the generating step is performed if the rendering information is not the character rendering information.

Hence, if the stored dot data corresponds to the character, the generation of the tag information is avoided, but if the dot data is not the character, the tag information can be generated. That is, there is the effect that it is possible to accurately switch between the generation and the non-generation of the tag information depending on whether or not the rendering object is the character.

The schematically generated character rendering information has the data indicating the formation of dot for the character image portion or the non-formation of dot for the margin portion other than the character image, separately from the color designation information for designating the color. Since the character of the rendering object is rendered based on this rendering information, it is possible to generate the dot data that can identify the portion corresponding to the rendering object (character image) and the other portion in the dot data. Accordingly, if it is revealed that the kind of rendering object is the character (the rendering information is the character rendering information), there is the effect that it is possible to avoid generating the unnecessary tag information by performing no generation of the tag information, and speed up the redisplay process for the preview image. Also, even if the character rendering object is superposed on the earlier displayed rendering object in the redisplayed preview image, it does not occur that the earlier displayed rendering object is covered with any other portion than the character in the dot data.

With the print control program product according to the eighth aspect of the invention, at the extracting step, a common area between the mask area information indicating a mask area contained in the mask information, and the rendering area information, if the rendering information acquired at the acquiring step has the mask information. If the extracted common area is rectangular, the rendering data of the portion corresponding to the common area is stored as the dot data at the dot data storing step.

Hence, it is possible that the portion of the rendering object not actually displayed as the image (portion other than the common area) is not stored as the dot data, and only the portion of the common area displayed (printed) as the image is stored as the dot data. The image data (dot data) of the rendering object tends to have an enormous amount of data capacity, but the dot data is not stored for the unnecessary portion not displayed as the image, whereby there is the effect that this program can be operated in an inexpensive system employing the cheap memory while the memory capacity required to store the dot data is suppressed. Also, in redisplaying the preview image, the process can be sped up because the processing amount of data is reduced.

With the print control program product according to the ninth aspect of the invention, at the specific information storing step, the tag presence information, the dot specific information and the tag specific information are stored for each rendering object. At the redisplaying step, one dot data corresponding to the rendering object is specified and displayed with the dot specific information stored at the specific information storing step, when the rendering object is redisplayed. Also, one tag information is specified with the corresponding tag specific information, and a portion of the rendering object is extracted and displayed from the dot data, based on the specified tag information, if the tag presence information is stored corresponding to the dot specific information.

Hence, in the apparatus in which this program is run, the correspondence between the dot specific information and the tag specific information can be accurately judged, whereby there is the effect that the throughput can be increased by shortening the processing time taken to retrieve (read) the dot data and the tag information corresponding to the rendering information. That is, since whether or not the tag information corresponding to the dot data is stored is indicated with the tag presence information, it is unnecessary to retrieve the storage area where the tag information is stored and confirm the presence or absence of the storage to check whether or not the tag information corresponding to the dot data is stored. The processing for retrieving the storage area where the tag information is stored and confirming the presence or absence of the storage is troublesome and takes a lot of time. Also, if the tag information is not stored, the wasteful processing results, and all the tag information must be confirmed, whereby the processing time is increased uselessly. However, this program can omit the processing for searching the storage area to investigate the presence or absence of this tag information by storing the tag presence information, whereby the processing speed can be increased.

With the print control program product according to the tenth aspect of the invention, the rendering order or the rendering area information of the rendering object is updated based on a change instruction at the editing step. At the redisplaying step, the corresponding rendering object is displayed in the dot data in accordance with the rendering order or the rendering area information after update. Herein, the initial values of the dot data stored at the dot data storing step are held, irrespective of whether or not the corresponding rendering order or the rendering area information is updated. That is, even if the edit is executed, the dot data of the first preview image is held.

Hence, there is the effect that the re-edit of the preview image can be made, and the initial preview image can be restored from the preview image after editing. For example, if a change instruction is issued from the apparatus mounting this program by a manipulation of the operator, the preview image generated based on this change instruction may be different from the operator's image. Also, as the operator edits the preview image greatly, the image may differ from the desired form of the operator. In such a case, it is often difficult to return to the original preview image by the edit operation. However, this program the dot data of the (first) preview image stored in the dot data storage means is not changed and holds the initial values even if the rendering order or the rendering area information of the rendering object is updated, whereby it is possible to return to the first preview image at any edit stage, so that the edit operation of the operator becomes more user-friendly.

[Illustrative Aspects]

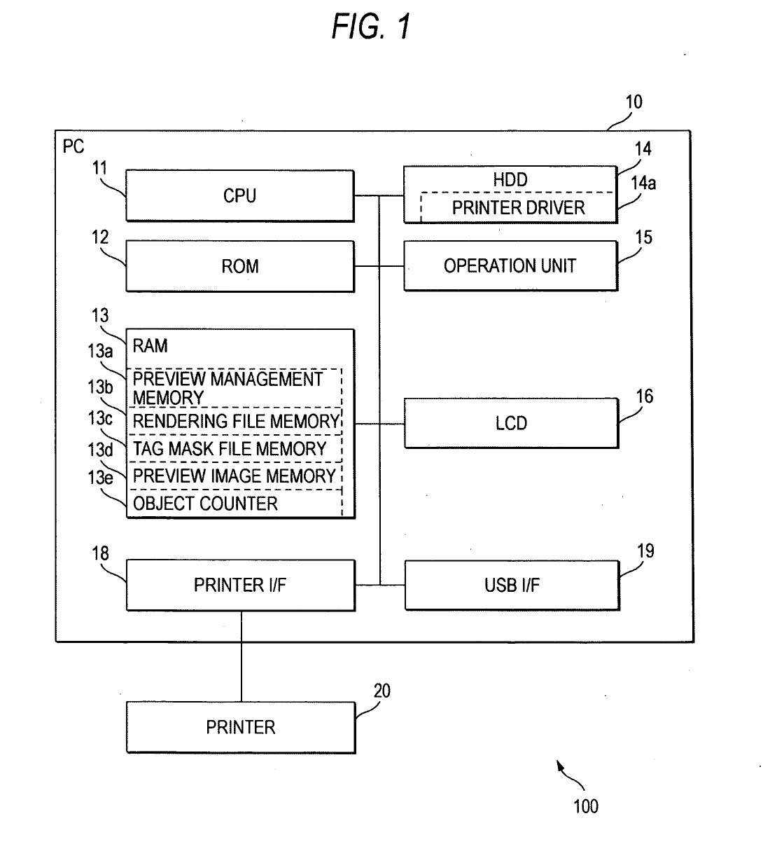

Illustrative aspects of the present invention will be described below with reference to the accompanying drawings. FIG. 1 is a block diagram showing the electrical configuration of a printing system 100 having a personal computer (hereinafter referred to as a “PC”) 10 mounting a printer driver 14a as a print control program product. As shown in FIG. 1, the printing system 100 comprises a PC 10 and a printer 20 connected to the PC 10.

The PC 10 creates image data using a document creation application program or an image creation application program and outputs the image data via a printer driver 14a to the printer 20, which is an output destination.

The printer driver 14a converts the image data from the application program into the print data (print instruction) corresponding to the printer 20, and outputs it to the printer 20. This printer driver 14a is provided with a preview function of displaying beforehand the printing result on an LCD 16 before outputting the print data to the printer 20. Also, the printer driver 14a can edit a preview image displayed by the preview function, whereby the preview image is edited based on an edit operation by the operator, and the preview image after editing is redisplayed on the LCD 16.

This PC 10 comprises a CPU 11, a ROM 12, a RAM 13, an HDD 14, an operation unit 15, an LCD 16, a printer interface (printer I/F) 18 for connecting the PC 10 to the printer 20, and a universal serial bus interface (USB I/F) 19 for connecting the PC 10 to the peripheral devices, as shown in FIG. 1.

The CPU 11 is an operation unit that operates based on a program stored in the ROM 12, an operating system (OS) and various application programs stored in the HDD 14, to perform various kinds of information processing. The ROM 12 is an unrewritable memory for storing a basic program for operating the CPU 11, and various kinds of data.

The RAM 13 is a rewritable memory for temporarily storing the data or program required for various kinds of processing performed by the CPU 11, and comprises a preview management memory 13a, a rendering file memory 13b, a tag mask file memory 13c, a preview image memory 13d and an object counter 13e.

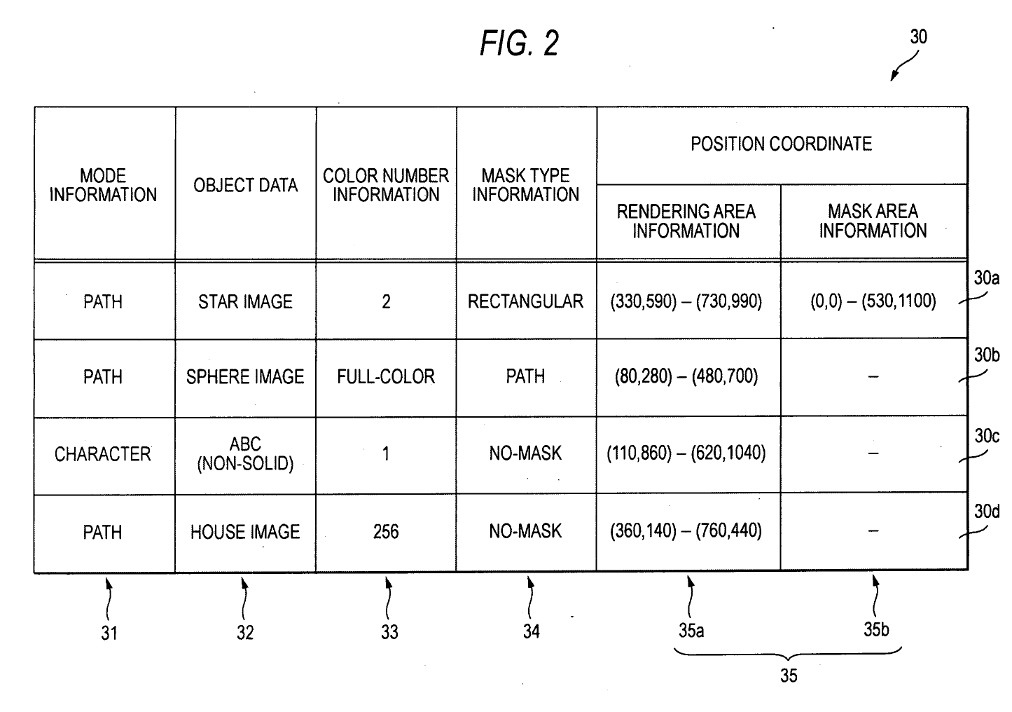

In the application program of the PC 10, the information (object data) forming the image within the image data is created in the format of vector graphics. The vector graphics represents the image as a set of information such as coordinates of points, parameters for an equation of the line or plane connecting the points, and fill or special effects. Generally, since the screen display of the computer or the printing method of the printer is in the bitmap format to deal with all kinds of images, the image data of the vector graphics can not be directly treated, whereby it is required to perform a process for converting into the dot data (bitmapped data) or a so-called dot expansion. That is, since the object is formed in accordance with the image data created by the application program, the image data from the application program becomes a rendering instruction 30 for generating the bitmapped data. Referring to FIG. 2, this rendering instruction 30 will be described below.

FIG. 2 is a view schematically showing the configuration of the rendering instruction 30. The rendering instructions 30 are acquired by the CPU 11 in the order sent out from the application program and recognized in succession. In FIG. 2, as one example of the rendering instruction 30, four rendering instructions 30a to 30d generated to form four objects (in one page of image) are shown, and displayed in the order in which the rendering instructions 30a to 30d are acquired from the upper stage to the lower stage. In FIG. 2, a series of information displayed in the same row corresponds to one rendering instruction 30.

As shown in FIG. 2, the rendering instruction 30 is a group of information in series formed in accordance with the kind of object to be rendered. The rendering instruction of different kind (mode) is created corresponding to the kind of object by the application program. More specifically, any one of a graphics rendering instruction (e.g., rendering instructions 30a, 30c and 30d) for generating the graphics with the path, a character rendering instruction (e.g., rendering instruction 30b) for generating the character with text data, and a bit map rendering instruction for generating the image with bitmapped data is created.

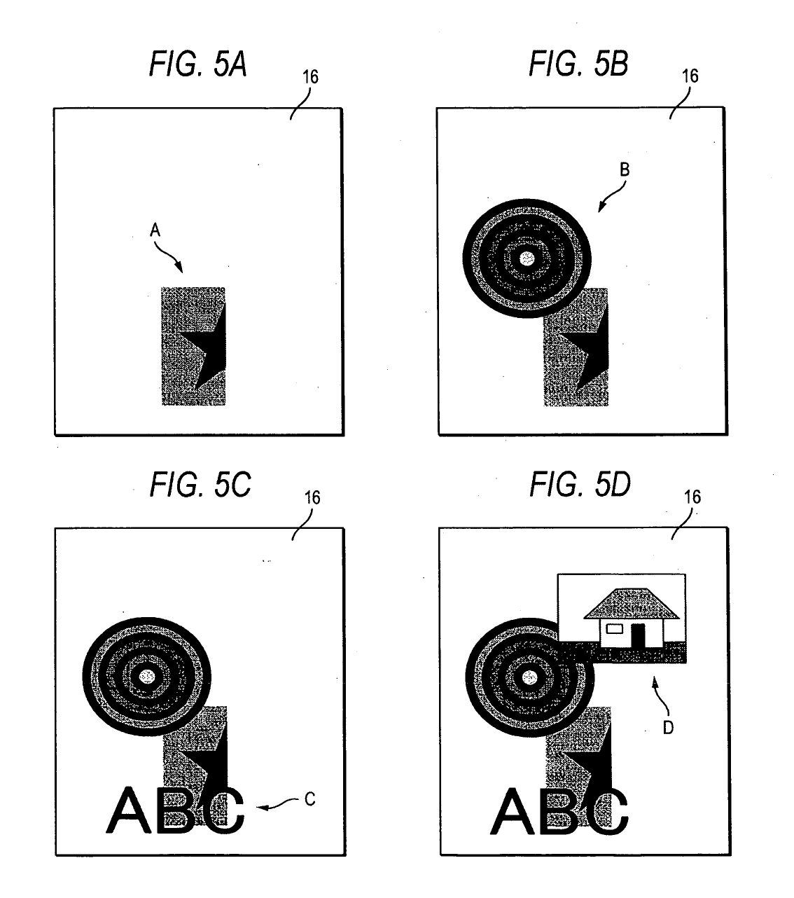

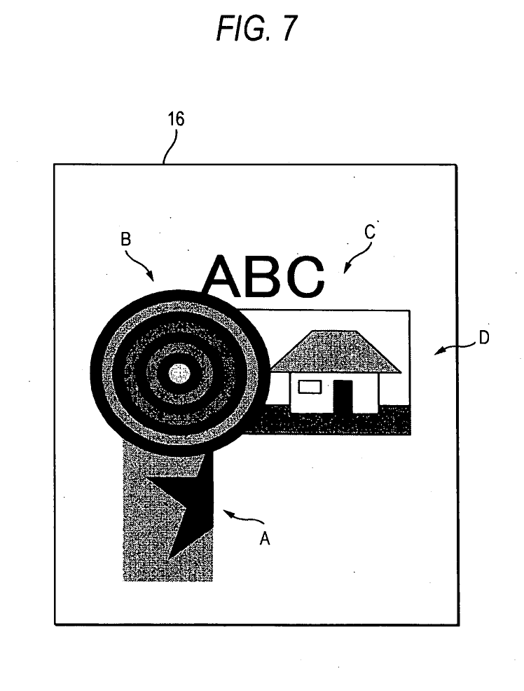

The CPU 11 performs the rendering in the order in which the rendering instructions 30 are acquired from the application program in generating the first preview image. In the example as shown in FIG. 2, the rendering is performed in the order of rendering instructions 30a, 30b, 30c and 30d. Thereby, the objects A, B, C and D corresponding to the rendering instructions 30a, 30b, 30c and 30d are respectively generated (see FIGS. 5A to 5C and 7). When a plurality of objects are overlaid in one page of the preview image, arranging a certain object on the rear side or the front side is determined by the order in which the rendering instructions are acquired.

Each rendering instruction 30 includes mode information 31, object data 32, color number information 33, mask type information 34 and position coordinate 35. The mode information 31 indicates the mode of the object rendered by the rendering instruction 30. In the graphics rendering instruction for rendering the object with the path, the “path” is included as the mode information (rendering instructions 30a, 30b and 30d). Also, in the character rendering instruction for rendering the object with text data, the “character” is included as the mode information (rendering instruction 30c). In the bit map rendering instruction for rendering the object with bitmapped data, the “bit map” is included as the mode information.

The object data 32 is the information forming the image, namely, the representation information representing the mode of the object and defining the shape or color of the object. Since the application program forms the image in the format of vector graphics, the object data 32 is composed of a group of information in which the data such as coordinates of points, parameters for an equation of the line or plane connecting the points, and fill (set-solid), color or special effects are set forth. In FIG. 2, the object data 32 for the rendering instructions 30 are schematically displayed as the “star image”, “spherical image”, “ABC” and “house image”. Also, the rendering instruction 30c is designated as the non-solid image in which the fill (background color, set-solid) does not appear on the rear face of character.

The color number information 33 indicates the maximum number of colors representable in a color representation system that is applied to the object. In the case where the formed object is the graphics, the color number information 33 is “2”, if the color representation system of two colors, black and white, called as a monotone, is applied, for example. Also, in the color representation system of three or more colors, there are three forms in which the maximum number of representable colors is 16, 256 or 16777216 (full-color). The color number information 33 is “16” for the object employing the 16-color form, the color number information 33 is “256” for the object employing the 256-color form, and the color number information 33 is “full-color” for the object employing the 16777216-color form. When the color number information 33 is “2”, the data representing the color has one bit (binary data) for one pixel, because all the data representing the color can be covered in one bit. Also, when the color number information 33 is “16”, the data representing the color has four bits for one pixel, when the color number information 33 is “256”, the data representing the color has eight bits for one pixel, and when the color number information 33 is “full-color”, the data representing the color has 24 bits for one pixel.

In FIG. 2, the rendering instruction 30a has “2” as the color number information 33, the rendering instruction 30b has “full-color” as the color number information 33, and the rendering instruction 30d has “256” as the color number information 33.

Also, the rendering instruction 30c has “1” as the color number information 33. Herein, the rendering instruction 30c is the character rendering instruction. In the case where the formed object is the character, the color number information 33 is indicated by the number of colors actually employed for the object of character. Since the object of character formed by the rendering instruction 30c is monochrome, the color number information 33 is “1”. Generally, the object of character is generated in a rectangular (square or oblong) range (frame) surrounding the periphery of the character string. A non-character portion within this frame can be set with the background color. For example, when the background color (background color of 1) is set, the color number information 33 is “2”.

The mask type information 34 indicates whether or not a mask M1 is set to the object. The mask M1 is superposed on the image of the object, and generated corresponding to the object by the application program.

The mask M1 serves to partition the object as defined by the object data 32 into a display portion and a non-display portion. The portion covered with the mask M1 is displayed, and the portion not covered with the mask M1 is not displayed.

The mask type information 34 is given depending on the outside shape of the object to be rendered. Each rendering instruction 30 includes any one of the “rectangular” information, “path” information and “no-mask” information as the mask type information 34.

The “rectangular” information indicates that the mask M1 is set to the object, and further the mask M1 and the display portion of the object set by the mask M1 are rectangular. The rendering instruction 30a as shown in FIG. 2 includes this “rectangular” information as the mask type information 34.

The “path” information and the “no-mask” information indicate that the mask M1 is not provided for the rendering instruction 30. Further, the “path” information indicates that the outside shape of the formed object is not rectangular, and is included in the rendering instruction 30 forming the object of curvilinear or indefinite shape. The rendering instruction 30b as shown in FIG. 2 includes this “path” information as the mask type information 34.

On the other hand, the “no-mask” information indicates that the outside shape of the object is rectangular. The rendering instructions 30c and 30d forming the rectangular object include this “no-mask” information. When the formed object is the character, the rectangular range containing the character string corresponds to one object, as described above. Therefore, the rendering instruction 30 of the character does not have the “path” information as the mask type information 34.

The position coordinate 35 is the information indicating the position, including the rendering area information 35a indicating the position (rendering area) of the object and the mask area information 35b indicating the position (mask area) of the mask.

This position coordinate 35 is the information indicating the position in terms of the X coordinate indicating the position on the X axis and the Y coordinate indicating the position on the Y axis orthogonal to the X axis. The position coordinate 35 of pixel (dot) at the upper left end of the image is defined as the X coordinate (0) and the Y coordinate (0). When the image is composed of 960×680 pixels, for example, the last coordinate of the X coordinate is 959 and the last coordinate of the Y coordinate is 679.

The rendering area information 35a indicates the positions of the object in the image of one page, namely, the range where the object is rendered, and is designated by the minimum coordinate and the maximum coordinate in the rectangular (square or oblong) range surrounded by four sides passing through the coordinates at both ends of the object in the X axis direction and the y axis direction. The minimum coordinate and the maximum coordinate are two vertices of such rectangular range. Since the rectangular (square or oblong) range is defined by the position coordinates 35 (minimum coordinate and maximum coordinate) of two diagonally opposite vertices, the rectangular range where the object is rendered can be indicated by this rendering area information 35a. Herein, when the object is rectangular, the range defined by the rendering area information 35a is coincident with the rendering area where the object is actually rendered.

For example, the rendering area information 35a for the rendering instruction 30a has the minimum coordinate (330,590) and the maximum coordinate (730,990) as shown in FIG. 2, whereby the rendering area is the rectangular range of which the vertices are the four coordinates (330,590), (730,590), (330,990) and (730,990).

The object formed based on the rendering instruction 30c or the rendering instruction 30d is the rectangular object, and the rendering area information 35a has the minimum coordinate (110,860) and the maximum coordinate (620,1040), and the minimum coordinate (360,140) and the maximum coordinate (760,440). Therefore, the rendering area of the actually rendered object is coincident with this rendering area information 35a.

On the other hand, the rendering area information 35a for the rendering instruction 30b is represented by the minimum coordinate (80,280) and the maximum coordinate (480,700). The mask type information 34 for this rendering instruction 30b is the “path” information, and the formed object is not rectangular. Since the rendering area information 35a is designated by the minimum coordinate and the maximum coordinate in the rectangular (square or oblong) range surrounded by four sides passing through the coordinates at both ends of the object in the X axis direction and the Y axis direction, this rendering area information 35a is the information indicating the smallest rectangular range containing the object, if the object is not rectangular. That is, the rendering area of the object is not directly indicated, but the object is contained in the rectangular range surrounded by four position coordinates (80,280), (480,280), (80,700) and (480,700) as defined by the minimum coordinate and the maximum coordinate of the rendering area information 35a.

The mask area information 35b is provided when the mask M1 is set to the object, and indicates the range (mask area) where the mask M1 is developed. The mask M1 is rectangular, and the minimum coordinate and the maximum coordinate of the four coordinates indicating the four vertices of the rectangle are stored as the mask area information 35b. If the mask M1 is developed, the rectangular range surrounded by the lines in the X axis direction and Y axis direction passing through the minimum coordinate and the lines in the X axis direction and Y axis direction passing through the maximum coordinate is defined, based on this mask area information 35b, whereby the mask M1 is developed over the defined range (mask area).

The rendering instruction 30a has the minimum coordinate (0,0) and the maximum coordinate (530,1100) as such mask area information 35b. This mask area is the range where the four coordinates (vertices of the rectangular shape) of (0,0), (530,0), (0,1100) and (530,1100) are connected by the line.

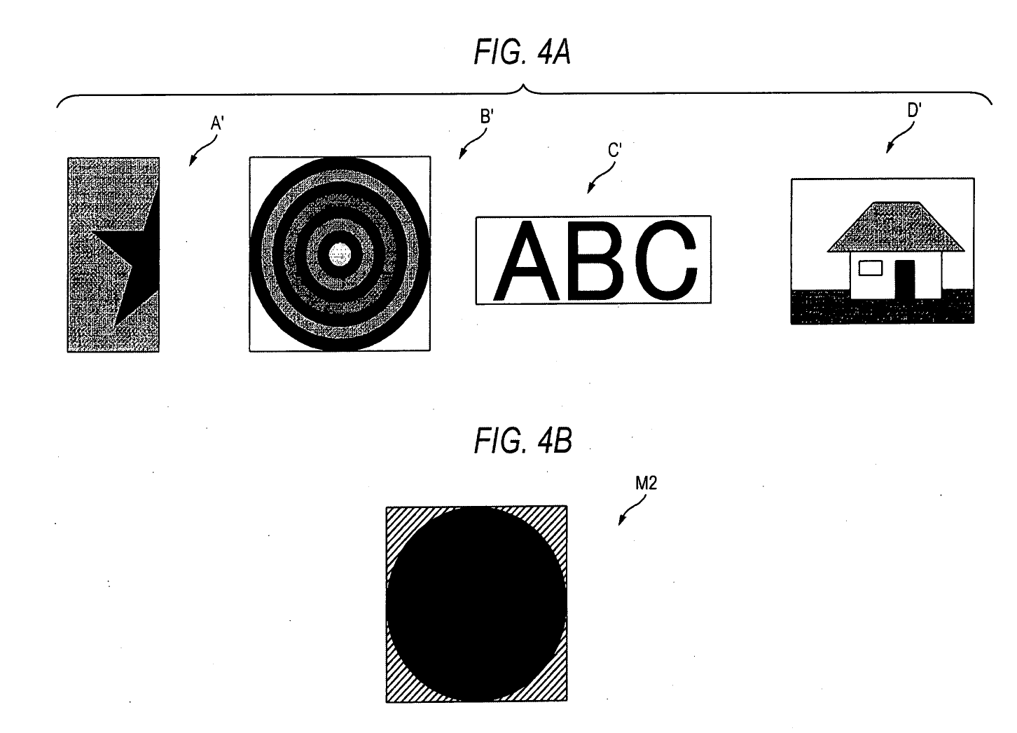

If printing the image data created by the application program of the PC 10 is requested, the printer driver 14a is started. Herein, if the output of the preview image is requested for the printer driver 14a, the rendering instruction 30 having the above configuration is called from the application program (acquisition of the rendering instruction), each object is rendered based on the acquired rendering instruction 30, whereby the bitmapped data is created (see FIGS. 4 and 5).

Returning to FIG. 1, the explanation is made.

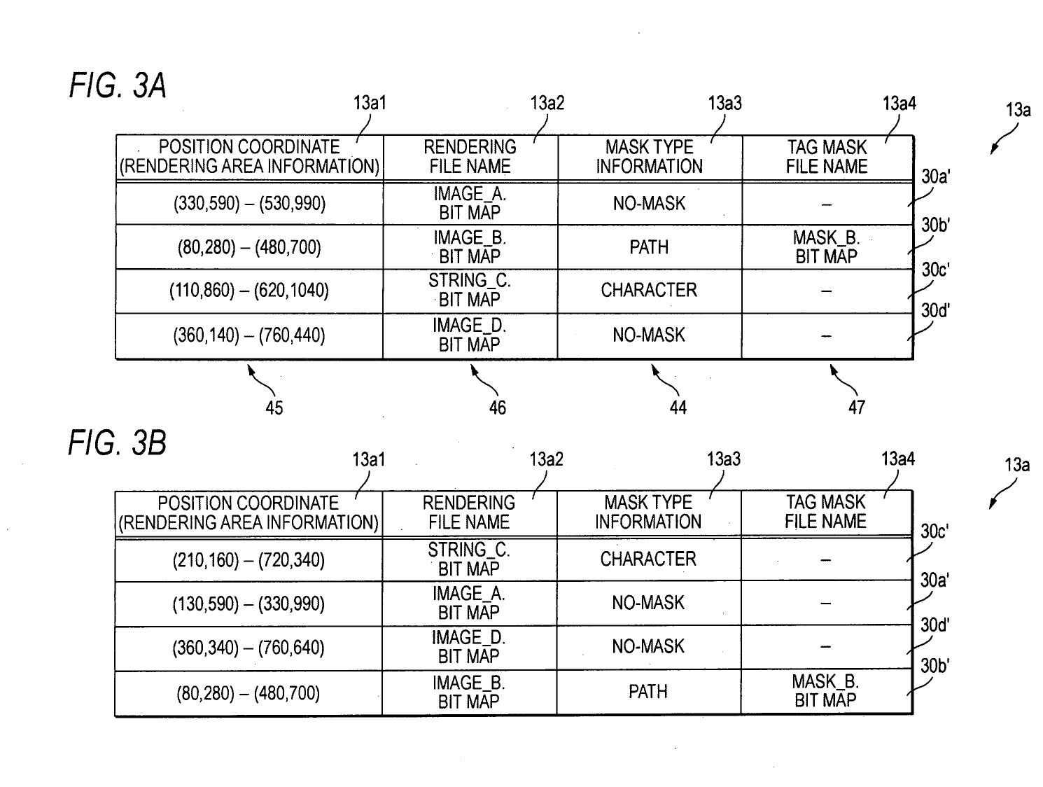

The preview management memory 13a manages the bitmapped data of each object (all the objects belonging to the image of one page) displayed in the preview image. The PC 10 generates the dot data by making the dot expansion of the rendering instruction 30 called from the application program with the preview function of the printer driver 14a, and creates the bitmapped data of each object from the generated dot data. The preview management memory 13a stores the information regarding the bitmapped data corresponding to each rendering instruction (each object) to manage this created bitmapped data. Referring to FIGS. 3A and 3B, this preview management memory 13a will be described below.

FIGS. 3A and 3B are views schematically showing the configuration of the preview management memory 13a. The information regarding the bitmapped data includes the position coordinate (rendering area information 45) of the bitmapped data (object), the rendering file name 46, the mask type information 44 and the tag mask file name 47. The preview management memory 13a is provided with the areas 13a1 to 13a4 for storing each information regarding such bitmapped data.

FIG. 3A shows the contents of the preview management memory 13a where the first preview image is generated in accordance with a display request for the preview image, or in other words, shows the contents of this preview management memory 13a where the object is generated by the rendering instruction 30 as shown in FIG. 2.

Accordingly, the preview management memory 13a stores the information 30a′ to 30d′ regarding the bitmapped data of each object generated by the rendering instruction 30a to 30d in the generated order, namely, in the order in which the rendering instructions 30 are acquired from the application program. In FIG. 3A, the information regarding the bitmapped data is displayed in the generated order, in which the information 30a′ regarding the bitmapped data corresponding to the rendering instruction 30a is displayed at the uppermost row, and at the succeeding rows, the information 30b′, 30c′ and 30d′ regarding the corresponding bitmapped data are displayed in the order of the rendering instructions 30b, 30c and 30d.

The position coordinate area 13a1 stores the position coordinate (rendering area information 45). In FIG. 3A, the position coordinate area 13a1 stores the rendering area information 45 for the first preview image. Herein, if the mask type information 34 for the rendering instruction 30 is the “rectangular” information, and the mask area information 35b is included in the rendering instruction 30, a common area (actually displayed object portion) between the rendering area of the object and the mask area is extracted, and stored as the rendering area information 45 of the object in the position coordinate area 13a1. Therefore, the rendering area information 45 is stored with the different values from the rendering area information 35b of the rendering instruction 30.

For example, the rendering area information 35a of the rendering instruction 30a includes the minimum coordinate (330,590) and the maximum coordinate (730,990) (see FIG. 2), as described above. The rendering area information 35a is the information indicating the rendering area of the original object formed by the object data 32. Herein, the rendering instruction 30a is provided with the mask area information 35b having the minimum coordinate (0,0) and the maximum coordinate (530,1100). Therefore, the extraction of the common area is executed, the common area (330,590), (530,590), (330,990) and (530,990) is extracted, and the minimum coordinate (330,590) and the maximum coordinate (530,990) of such rectangular area are stored in the position coordinate area 13a1 as rendering area information 40.

If the mask area information 35b is not included in the rendering instruction 30, the rendering area information 35a for the rendering instruction 30 is directly stored as the rendering area information 45 in the position coordinate area 13a1, in the case of the rendering instructions 30b to 30d.

The rendering file name area 13a2 stores the rendering file name 46. The rendering file name 46 is the information designating the file (rendering file) of the bitmapped data of the created object. The bitmapped data of the created object is stored as the rendering file in the bit map file format. The stored rendering file is given a unique file name not overlapping the other file names, and the given rendering file name 46 is written into the rendering file name area 13a2.

The mask type area 13a3 stores the mask type information. The rendering instruction 30 has any one of the “rectangular” information, the “path” information and the “no-mask” information as the mask type information 34, as described above. The mask type information 44 based on the mask type information 34 provided for such rendering instruction 30 is stored in this mask type area 13a3.

More specifically, the mask type information 34 given by the rendering instruction 30 is the “path” information or the “no-mask” information, the “path” information or the “no-mask” information is directly stored as the mask type information 44 in this mask type area 13a3. Also, if the mask type information 34 for the rendering instruction 30 is the “rectangular” information (rendering instruction 30a), the information of the mask area is unnecessary because the rendering area (rendering area information 45) of the object is changed to the values reflecting the mask M1, whereby the mask type information 44 stored in the mask type area 13a3 is the “no-mask” information.

Also, the mask type information 44 stored in this mask type area 13a3 is the information indicating the presence or absence of the tag mask M2 corresponding to the object. If the mask type information 44 is the “no-mask” information, it is indicated that the tag mask M2 does not exist, or if the mask type information 44 is the “path” information, it is indicated that the tag mask M2 exists.

Moreover, in the case where the bitmapped data of the non-solid character is generated, the mask type area 13a3 stores the “character” information as the mask type information 44. If the object is the set-solid character, it can be treated in the same manner as the rectangular graphics, whereby the mask type information 44 is stored as the “no mask” information in the mask type area 13a3 even though the generated bitmapped data is the character.

The tag mask file area 13a4 is the memory storing the file name (tag mask file name 47) of the tag mask M2. If the mask type information 34 of the rendering instruction 30 is the “path” information, the tag mask M2 is generated together with the bitmapped data of the object, and stored as the tag mask file. Accordingly, if the mask type information 34 for the rendering instruction 30 is the “path” information (rendering instruction 30b), the tag mask file name 47 is stored in the corresponding tag mask file area 13a4.

When the preview image is displayed, the CPU 11 selects the corresponding tag mask by referring to the tag mask file name 47 stored in this tag mask file area 13a4, and superposes the bitmapped data on the object to be masked to display the object on the LCD 16.

As described above, the preview management memory 13a stores the information regarding the bitmapped data of the object in the rendering order. Herein, each rendering instruction, the information regarding each bitmapped data and each object (e.g., the rendering instruction 30a, the information 30a′ regarding the bitmapped data, and the object A) are associated with each other, in which the information 30a′ to 30d′ regarding the bitmapped data of each object are stored in the order of objects A, B, C and D in the preview management memory 13a as shown in FIG. 3A. Accordingly, the objects are displayed in the order of objects A, B, C and D in this case.

FIG. 3B shows the preview management memory 13a after editing the preview image displayed with the contents of the preview management memory 13a of FIG. 3A. The printer driver 14a has an edit function of the preview image, enabling the movement, scale-up/scale-down or deletion of the object and the change of the rendering order to be made from the display screen of the preview image, based on an operation on the operation unit 15 (keyboard and mouse) by the operator. If the movement or scale-up/scale-down of the object is made, the rendering area information 45 is changed in accordance with the movement amount or scaling factor, whereby the rendering area information 45 of the position coordinate area 13a1 is updated with the values after change. Also, if the deletion of the object is performed, the information corresponding to the deleted object is deleted from the preview management memory 13a. If the change of the rendering order is performed, the storage order (storage location, data list) of the information regarding the bitmapped data in the preview management memory 13a is changed.

In FIG. 3B, the rendering order is changed by editing the preview image, where by the information 30a′ to 30d′ regarding the bitmapped data stored in the order of objects A, B, C and D is changed into the storage order corresponding to the objects C, A, D and B. Further, it is indicated that the edit of moving the object positions of the objects A, C and D is performed in the rendering area information 45 of the position coordinate area 13a1 corresponding to the information regarding the bitmapped data.

Returning to FIG. 1, the explanation is made.

The rendering file memory 13b stores the bitmapped data of each object displayed in the preview image. Each bitmapped data is given a filename as one rendering file, and individually managed as the rendering file. Also, the given rendering file name 46 is written into the preview management memory 13a as described above. The CPU 11 selects the corresponding rendering file (one bitmapped data) from the rendering file name 46 stored in the preview management memory 13a and displays the object based on the bitmapped data, in displaying (or redisplaying) the preview image.

The bitmapped data is created in the rectangular shape, and an aggregate of color points (dots or pixels), in which each pixel is indicated by the color values such as the RGB values. Therefore, if the object to be converted into the bitmapped data is not rectangular, the bitmapped data of its object is generated by containing the portion other than the object.

For the object portion of such bitmapped data, each pixel belonging to its object is formed with the color values (RGB values) according to the rendering instruction 30. However, the margin portion other than the object has no original data, whereby some new data must be generated. Generally, each pixel in the margin portion of such bitmapped data is given the value of while color.

Herein, the character rendering instruction, unlike the graphics rendering instruction, is indicated by the data of character color (and background color), separately from the graphic data indicating the shape of character. In other words, the graphic data indicating whether or not the dot is formed within the rendering area is the independent data provided separately from the data of color.

If the object of character is non-solid, the character itself has no regular shape, like the irregular-shaped graphics, and further the portion other than the character within the rendering area is colorless. Such a mode is apparently the same as the image data is not rectangular, but the data structure itself is different, whereby it is clarified that the margin portion is blank (with the information designating it as the portion where the dot is not formed). Accordingly, the object (character) portion can be only indicated without creating the tag mask M2. Therefore, if the object is the character, the bitmapped data represented by the binary data indicating the display or non-display of each pixel is generated (based on the rendering instruction 30). If the background color (set-solid) is designated in the rendering instruction 30 of the character (character rendering instruction), the bitmapped data of the object of that character is generated as the usual bitmapped data (each pixel is represented by the color values), like the rectangular graphics, because it is unnecessary to discriminate whether the margin portion is white or colorless (non-display portion).

The tag mask file memory 13c stores the tag mask M2. The tag mask M2 is created, if the mask type information 34 of the rendering instruction 30 is the “path” information, namely, if the outside shape of the generated object is not rectangular. The tag mask M2 is given the file name as the one tag mask file, and managed individually as the tag mask file. Also, the given tag mask file name 47 is written into the preview management memory 13a as described above. In displaying the preview image, the CPU 11 selects the corresponding tag mask file from the tag mask file name 47 stored in the preview management memory 13a and displays the object on the LCD 16 based on the bitmapped data of the object and the tag mask M2.

The tag mask M2 is the data formed with the portion corresponding to the object within the bitmapped data of the object as the value of black color and the other portion than the object as the value of white color to discriminate the actual object portion in the bitmapped data of the object. The tag mask M2 is generated to discriminate the actual object portion in the bitmapped data of the object, and unnecessary if the object is rectangular or if the object is the character. Accordingly, in such a case, the tag mask M2 is not generated. Thereby, the processing for creating the tag mask M2 can be minimized if required, whereby the processing time for creating the preview image is shortened.

The bitmapped data of the non-rectangular (graphic) object is made rectangular by adding the white margin portion to the peripheral portion of the original object. Therefore, when it is directly displayed in the preview image, the white peripheral portion may overlap the other object, depending on the arrangement (position coordinate or rendering order) of the object. The other object (a part thereof) is not displayed by the portion that is not the image of the original object. In such a case, the role of the preview that the image of the printing result is presented to the operator by the preview image before printing is not only insufficiently fulfilled, but also the non-display portion is not printed and a part of the image to be displayed is lost, if the printing is directly performed, whereby the printing result as desired by the operator can not be obtained.

To solve this problem, if the pixel with the value of white color is simply not displayed, the image portion of white color to be displayed is also lost. Also, even if the value of other than white color is applied to the margin portion other than the object of the bitmapped data, the applied color must be made the color that can not be displayed, restricting the color representation. However, the tag mask M2 is stored in the tag mask file memory 13c, and the actual object portion in the bitmapped data of the object can be discriminated by referring to such tag mask M2, whereby the portion of the object can be selectively displayed. Hence, even if the preview image is displayed in the bitmapped data, there is no change to the display mode against the operator's intention due to the overlap of the bitmapped data, or no restriction on the color representation.

Even if the edit such as movement or scale-up/scale-down of the object is made, neither the contents of the rendering file stored in the rendering file memory 13b nor the contents of the tag mask M2 stored in the tag mask file memory 13c are changed, whereby the initial values are held. Accordingly, if the edit such as movement or scale-up/scale-down is made, the rendering area information 45 in the preview management memory 13a is only updated. And the bitmapped data according to the rendering area information 45 after update is generated from the rendering file (bitmapped data of the object) or the tag mask read from the rendering file memory 13b or the tag mask file memory 13c, and the object is displayed on the LCD 16.

The preview image memory 13d stores the bitmapped data of the preview image actually displayed on the LCD 16. Each object created based on the information regarding the bitmapped data stored in the preview management memory 13a is written into the preview image memory 13d, and then outputted to the LCD 16. Also, if a print request is made, the bitmapped data stored in the preview image memory 13d is converted into the print data and outputted to the printer 20.

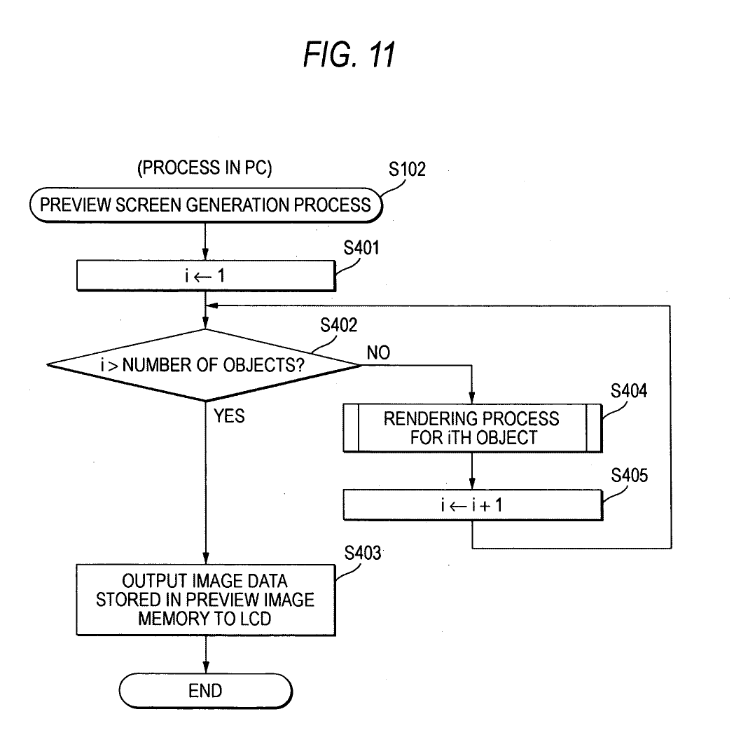

The object counter 13e counts the number of rendered objects (for judging whether or not the rendering for all the objects is ended), as well as designating the object to be rendered in a preview screen generation process (see FIG. 11) for generating the preview image. The count value of the object counter 13e is set at “1” at the timing when the preview screen generation process is started, and incremented by one every time when the rendering of the object is ended, until its count value exceeds the number of information regarding the bitmapped data stored in the preview management memory 13a, namely, the number of all the objects belonging to the image of one page.

The HDD 14 is a hard disk reading device containing a hard disk, and has the printer driver 14a. This HDD 14 stores various kinds of control programs, such as the application program and the OS, not shown, in addition to the printer driver 14a. The CPU 11 performs the process in accordance with the various kinds of control programs. Also, the HDD 14 stores a look-up table for converting the color representation system (RGB values) in the PC 10 into the color representation system (CMYK values) according to the printer 20.

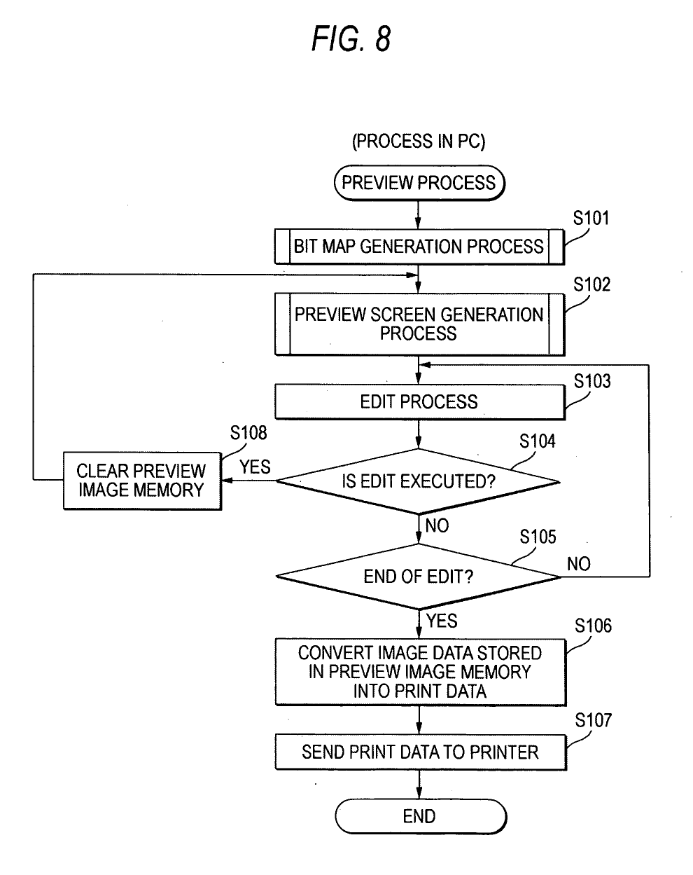

The printer driver 14a is the program for converting the document data or image data created by various kinds of application, such as a document creation application or an image creation application, into the print data that can be processed by the printer 20 and outputting the print data to the printer 20. The programs as shown in the flowcharts of FIGS. 8 to 12 are stored as a part of this printer driver 14a.

The PC 10 performs the rendering process for the rendering instruction 30 created by the application program in accordance with the printer driver 14a, to generate the dot data (print image data) of the RGB values. Thereafter, the original image data is subjected to various kinds of processes such as a color conversion process for converting the RGB values into the CMYK values and a binarization process, and converted into the print data.

Also, the printer driver 14a has the preview function of displaying the printing result on the LCD 16 before outputting the print data to the printer 20, as described above, and an edit function of editing the preview image displayed on the display screen. The details of the process regarding the preview function performed by this printer driver 14a will be described later with reference to the flowcharts of FIGS. 8 to 12.

The operation unit 15 is used to input the data or command into the PC 10, and comprises a keyboard and a mouse. The LCD 16 displays the character or the image to visually confirm the processing contents executed on the PC 10 or the input data. The preview image created by the printer driver 14a is displayed on this LCD 16, as described above.

The I/F 18 connects the PC 10 to the printer 20. The PC 10 sends the print command or print data to the printer 20 via this I/F 18, and the printer 20 performs the printing on the recording sheet. The USB I/F 19 connects the peripheral device to the PC 10 in accordance with the USB standard. The sending or receiving of data is performed via this USB I/F 19 between the connected peripheral device and the PC 10.

As shown in FIG. 1, the CPU 11, the ROM 12, the RAM 13, the HDD 14, the operation unit 15, the LCD 16, the I/F 18 and the USB I/F 19 are interconnected via the bus line 17.

Also, the PC 10 is connected to the printer 20 as the output destination of the print data, as shown in FIG. 1. Such printer 20 comprises a motor for conveying the recording medium, a print head for discharging the ink onto the recording medium to form the image, a carriage motor for driving (moving) the print head, and an interface for connecting to the PC 10, in addition to the CPU of an operation unit, the ROM that is an unrewritable non-volatile memory storing the control program executed by the CPU, the RAM that is a rewritable volatile memory temporarily storing various kinds of data when the control program is executed by the CPU. Such printer 20 is a typical ink jet printer for printing the print data received via the interface from the PC 10 on the recording medium.

The printer 20 is not necessarily the ink jet printer, but may be a laser printer that performs the printing with the toner. Also, the apparatus connected to the PC 10 is not limited to the printer, but may be a facsimile apparatus or copying machine having the printer function, or a combination thereof.

Referring to FIGS. 4 to 7, a production process for the preview image performed by the printer driver 14a will be described below.

FIG. 4 is a view showing the bitmapped data created based on the rendering instruction 30 from the application program. More specifically, FIG. 4A shows the bitmapped data of the objects A to D generated based on the rendering instructions 30a to 30d as shown in FIG. 2. In FIG. 4, the bitmapped data corresponding to the objects A to D are designated with A′ to D′.

Each object rendered based on the rendering instruction 30 is partitioned like a rectangle, thereby generating a rendering file in which the dot data in its rectangular range is the bitmapped data of the object. Herein, the partitioned rectangular range is defined by the rendering area information 35a for the rendering instruction 30. More particularly, if the rendered object is rectangular, and its rendering area is coincident with the rendering area as indicated by the rendering area information 35a included in the rendering instruction 30 (rendering instructions 30c, 30d, namely, the objects C, D), the dot data expanded in the rendering area designated by the rendering area information 35a for the rendering instruction 30 is stored directly as the bitmapped data (C′, D′ in FIG. 4) of the object in the rendering file memory 13b. Since the character object is the rectangular object, the bitmapped data is necessarily generated in the rendering area as indicated by the rendering area information 35a included in the rendering instruction 30, as described above.

Also, if the rendered object is rectangular and the mask area information 35b is included in the rendering instruction 30 (rendering instruction 30a, object A), the bitmapped data (A′ in FIG. 4) of only the portion belonging to the mask area is generated. That is, the bitmapped data is generated not in the rendering area designated by the rendering area information 35a included in the rendering instruction 30, but in the range of the common area between the rendering area defined by the rendering area information 35a and the mask area defined by the mask area information 35b.

Moreover, if the rendered object is not rectangular (rendering instruction 30b, object B), the bitmapped data (B′ in FIG. 4) is generated in the rectangular range including the periphery of the rendered object. This is because the bitmapped data is rectangular data. In such a case, the bitmapped data is generated in the rectangular (square or oblong) range (rectangular range as defined by the rendering area information) surrounded by four sides passing through the position coordinates at both ends in the X axis direction and the Y axis direction for the expanded dot data. Therefore, such bitmapped data (B′) contains the object and the margin portion other than the object.

Though the generated bitmapped data is stored in the value of color for each dot of the rendered object, and the bitmapped data of the margin portion is stored in the value of white color, the value of color for the margin portion is not limited to the value of white color but the other colors may be applied. Further, the bitmapped data may have the data of transparency for each dot together with the value of color.

FIG. 4B shows the bitmapped data of the tag mask M2 generated for the non-rectangular object in generating the preview image. In a case of the non-rectangular object, the tag mask M2 for the bitmapped data (B′) of the object B is generated for the object B corresponding to the rendering instruction 30b. The bitmapped data of the generated tag mask M2 is stored as the tag mask file in the tag mask file memory 13c.

In generating this tag mask M2, first of all, the dot data of the corresponding object rendered in accordance with the rendering instruction 30 is stored as the dot data with the value of black color. If the rendering is made in accordance with the rendering instruction 30, only the object portion is rendered, whereby the dot data with the value of black color becomes the information for tagging the rendered portion of the object (displayed with black fill in FIG. 4B). Thereafter, the rectangular range of the bitmapped data is defined from the rendering area information 35a included in the rendering instruction 30 for the rendered object. Since the rectangular range as defined by the rendering area information 35a is coincident with the generation range of the bitmapped data, a portion where the value of black color is not given within such rectangular range is recorded as the dot data with the value of white color. That is, the dot data with the value of white color becomes the information for tagging the margin portion (non-object portion) of the object in the bitmapped data (as displayed by the diagonally shaded part in FIG. 4B) And the bitmapped data of the tag mask M2 for distinguishing the object portion and the non-object portion in the bitmapped data are generated by synthesizing the value of black for tagging this rendered portion and the value of white for tagging the margin portion (non-object portion).

FIG. 5 is a view showing the preview image displayed on the LCD 16 when the display of the preview image is requested, namely, the preview image firstly displayed in accordance with a display request, and its generation process. In FIG. 5, the preview image generated based on the rendering instruction 30 of FIG. 2 and the information regarding the bitmapped data of FIG. 3 is illustrated. If a print process is requested from the application program to the printer driver 14a, each of the objects (objects A to D) belonging to the preview image is generated in accordance with the rendering instruction 30 called from the application program.

If the data (object data 32) forming each object is in the vector graphics format, the bitmapped data of each object is created from the dot data after the data is converted into the dot data (dot expansion, rendering) by computation. Also, the generation of the tag mask M2 corresponding to the bitmapped data and the write of the information regarding each bitmapped data into the preview management memory 13a are executed. After the generation of the bitmapped data is ended for all the rendering instructions 30 for the image of one page, each object is displayed successively at the rendering position (area) designated by the rendering area information 45 stored corresponding to each created bitmapped data by referring to the preview management memory 13a.

Herein, if the information 30a′ to 30d′ regarding the four bitmapped data corresponding to the four objects A to D belonging to the image of one page are stored in the preview management memory 13a as shown in FIG. 3, the information 30a′ corresponding to the object A stored at the initial address of the preview management memory 13a (of the first rendering order) among such information is firstly read. Also, the information 30b′ to 30d′ stored in the preview management memory 13a are read successively.

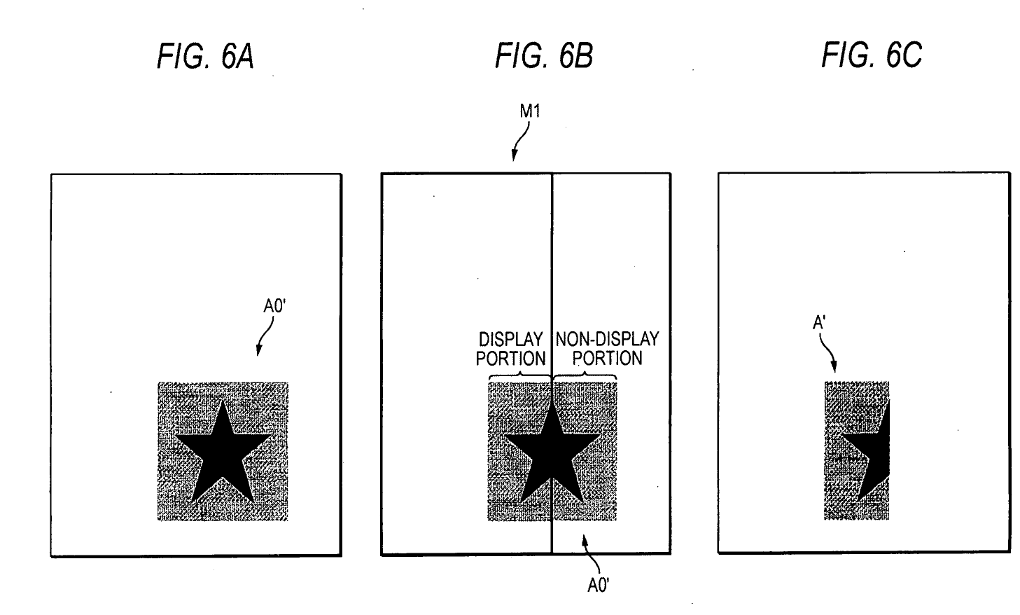

Thereafter, firstly, the object A based on the bitmapped data (A′, see FIG. 4) corresponding to the information 30a′ is displayed at the position as indicated by the rendering area information 45 on the LCD 16. Since the rendering instruction 30a corresponding to the object A includes the information of the mask M1, a part of the original object A0 is displayed as the object A (FIG. 5A). Referring to FIG. 6, the production process for the bitmapped data of the object where the information of the mask M1 is included in the rendering instruction 30 will be described below.

FIG. 6 is a view showing the image in generating the bitmapped data of the object with the mask M1 set. If the mask M1 is set to the object, the original object as defined in the object data 32 is not directly displayed, but partly not displayed. Hence, it is required to exclude the non-display portion from the display image.

Therefore, if the rendering is performed in accordance with the object data 32 of the rendering instruction 30a, the bitmapped data A0′ corresponding to the original object A0 is generated (FIG. 6A). And the common are a between this bitmapped data A0′ and the mask M1 is recognized as the display portion by the CPU 11, while the non-common area between the bitmapped data A0′ and the mask M1 is recognized as the non-display portion where the display is not made by the CPU 11 (FIG. 6B). As a result, the bitmapped data (A′) corresponding to a part of the original object is stored as the bitmapped data formed by the rendering instruction 30a in the rendering file (FIG. 6C). Thereby, the object A that is a part of the original object A0 is displayed on the LCD 16 by the bitmapped data (A′).

Returning to FIG. 5, the explanation is made. After the display of the object A is ended, the object B based on the bitmapped data (B′, see FIG. 4) corresponding to the information 30b′ stored in the second rendering order in the preview management memory 13a is displayed at the position indicated by the rendering area information 45 on the LCD 16. Because apart of the rendering area of the object B overlaps the rendering area of the object A, a part of the object A displayed ahead is covered with the object B and not displayed (FIG. 5B).

Next, the object C based on the bitmapped data (C′, see FIG. 4) corresponding to the information 30c′ stored in the third rendering order in the preview management memory 13a is displayed at the position indicated by the rendering area information 45 on the LCD 16. Because the rendering area of the object C is set under the rendering area of the object A, the object C is displayed under the object A and on the front face of the object A (FIG. 5C). Lastly, the object D based on the bitmapped data (D′, see FIG. 4) corresponding to the information 30d′ stored in the fourth rendering order in the preview management memory 13a is displayed at the position indicated by the rendering area information 45 on the LCD 16. The preview image is completed by displaying the object D (FIG. 5D)

Herein, the object B is displayed for only a portion of the bitmapped data (B′) designated (tagged) as the object by the tag mask M2, whereby the object is displayed in the correct mode to be displayed in which the margin portion of the bitmapped data is not displayed.

FIG. 7 is a view showing the preview image after the preview image of FIG. 5 is edited. If the edit is performed, the contents of the preview management memory 13a are updated, and the preview image is redisplayed on the LCD 16, based on the updated contents. Since the edited contents are stored in the preview management memory 13a, the preview image after editing is created in accordance with the contents of the preview management memory 13a. Also, each object in the preview image is displayed based on the bitmapped data (A′, B′, C′ and D′) read from the rendering file stored in the rendering file memory 13b. Therefore, the preview image is redisplayed promptly after editing. The redisplayed preview image of FIG. 7 is generated in accordance with the contents of the preview management memory 13a as shown in FIG. 3B.

More specifically, for the object A, the rendering area information 45 having the minimum coordinate (330,590) and the maximum coordinate (530,990) in the first preview image is changed to the minimum coordinate (130,590) and the maximum coordinate (330,990). Accordingly, the display position of the object A is shifted to the left on the screen after editing. For the object C, the rendering area information 45 having the minimum coordinate (110,860) and the maximum coordinate (620,1040) in the first preview image is changed to the minimum coordinate (210,160) and the maximum coordinate (720,340) after editing. Accordingly, the display position of the object C is shifted to the upper right on the screen. For the object D, the rendering area information 45 having the minimum coordinate (360,140) and the maximum coordinate (760,440) in the first preview image is changed to the minimum coordinate (360,340) and the maximum coordinate (760,640). Accordingly, the display position of the object D is shifted downward on the screen.

Also, at the initial time (when the first preview image is generated), the preview management memory 13a stores the information 30a′ to 30d′ regarding the bitmapped data in the order of objects A, B, C and D. However, since the storage order is changed to the order of objects C, A, D and B by editing, the objects are reallocated in the order in which the object C is on the rearmost face, and the objects A, D and B are on the front side (the object B on the foremost face).

Referring now to the flowcharts of FIGS. 8 to 12, each process of the printer driver 14a performed by the PC 10 configured in the above manner will be described below. FIG. 8 is a flowchart of the preview process involving the preview and print process of the image data. This preview process is executed when the printer driver 14a is started. The printer driver 14a is started upon a print request from the application program as a momentum.

In this preview process, first of all, a bit map generation process for generating the bitmapped data of the object and the bitmapped data of the tag mask M2 from the rendering instruction 30 called from the application program is performed (S101). A preview screen generation process for displaying the preview image with the generated bitmapped data is performed (S102). Thereafter, an edit process for editing the preview image based on an operation of the operator is performed (S103).

In this edit process, for each object of the displayed preview image, the movement, scale-up/scale-down or deletion of the designated object or the change of the rendering order is performed based on an operation of the operator on the operation unit (keyboard and mouse), whereby the rendering area information 45 of the position coordinate area 13a1 in the preview management memory 13a is updated in accordance with a change by the edit operation. Also, the rendering order (data order of the preview management memory 13a) is interchanged.

Thereafter, in the edit process (S103), it is confirmed whether or not the edit of the preview image is performed (S104). If the edit is not performed (S104: No), it is confirmed whether or not the end of edit is requested (S105). This edit end request is recognized by the CPU 11 when an edit end command is inputted by the operation of the operator. As a result of confirmation, if the end of edit is requested (S105: Yes), the image data (bitmapped data) stored in the preview image memory 13d is converted into the print data (S106), the print data is sent to the printer 20 (S107), and this preview process is ended.

On the other hand, as a result of confirmation at step S104, if the edit is performed (S104: Yes), the preview image memory 13d is cleared (S108) to be in a state for starting the rendering of the new bitmapped data, and the operation goes to step S102.

Also, as a result of confirmation at step S105, if the end of edit is not requested (S105: No), the operation goes to the edit process (S103) to wait for the edit to be performed or ended.

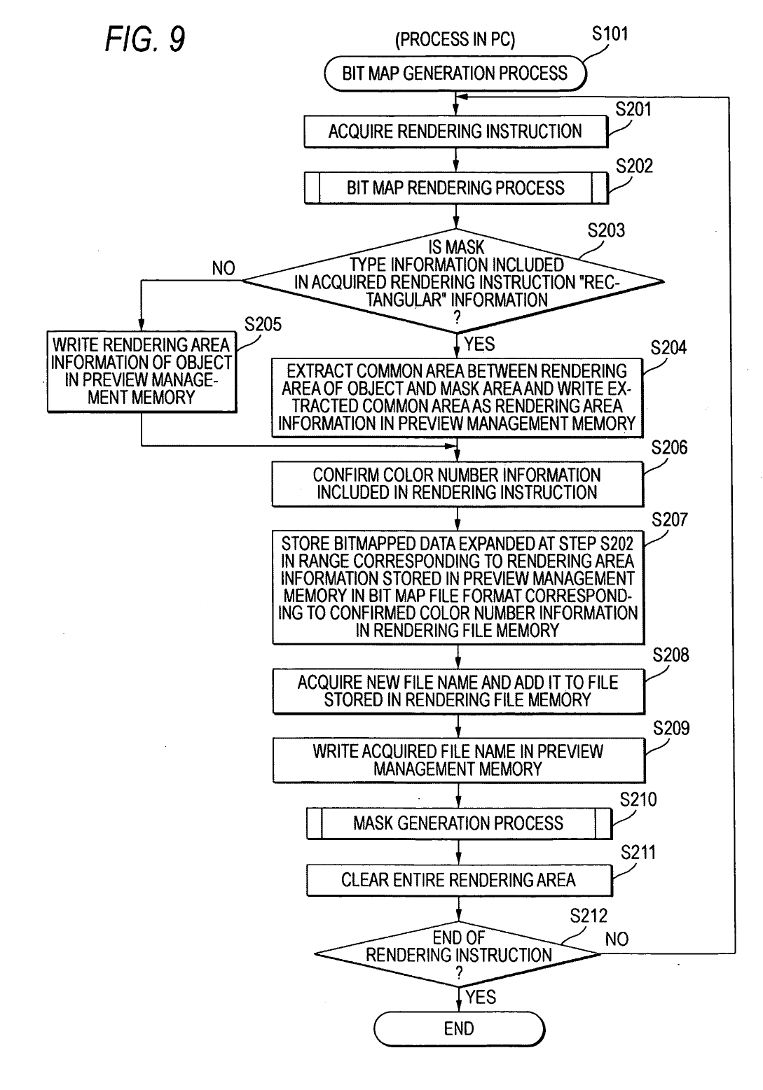

FIG. 9 is a flowchart of the bit map generation process (S101) that is performed in the preview process of FIG. 8. In this bit map generation process (S101), first of all, the rendering instruction 30 sent from the application program is acquired (S201). In this bit map generation process (S101), the process following step S202 is performed (for the acquired rendering instruction 30) every time of acquiring one rendering instruction 30.

The object is rendered in accordance with the acquired rendering instruction 30. That is, a bit map rendering process for making the dot expansion of the object data 32 in the rendering area (a part of the operative area of the RAM, where the dot expansion of the rendering instruction 30 is made) is performed (S202). Then, it is confirmed whether or not the mask type information 34 included in the acquired rendering instruction 30 is the “rectangular” information (S203). As a result, if the mask type information 34 of the rendering instruction 30 is the “rectangular” information (S203: Yes), the common area is extracted from the rendering area of the object and the mask area in the rendering instruction 30, and the extracted common area is written as the rendering area information 45 in the position coordinate area 13a1 of the preview management memory 13a in association with the rendering instruction (corresponding to the rendering instruction) (S204). On the other hand, if the mask type information 34 of the rendering instruction 30 is not the “rectangular” information (S203: No), the rendering area information 35a of the acquired rendering instruction 30 is directly written (as the rendering area information 45) in the corresponding position coordinate area 13a1 of the preview management memory 13a in association with the rendering instruction (corresponding to the rendering instruction) (S205).

After the step S204 or S205, the color number information included in the rendering instruction 30 is confirmed (S206). The bitmapped data of the object formed by dot expansion from the rendering instruction 30 at step S202 in the range of the rendering area designated by the rendering area information 45 stored in the preview management memory 13a is stored as the rendering file in the bit map file format corresponding to the confirmed color number information in the rendering file memory 13b (S207). Thereby, the bitmapped data of the object is formed (see FIG. 4).

The color number information indicates the maximum number of colors that can be represented in the color representation system applied to the object. The bitmapped data is generated with a different number of bits depending on the number of representable colors. Accordingly, the color number information is confirmed, and the bitmapped data can be stored with an exact number of bits according to the number of colors in the bitmap format corresponding to the confirmed color number information.

Thereafter, the new file name (unique file name) is acquired, and given to the rendering file stored in the rendering file memory 13b (S208). Then, the acquired file name (rendering file name 46) is written into the preview management memory 13a in association with the rendering area information 45 stored at step S204 or S205 (S209). Subsequently, a mask generation process for generating the tag mask M2 is performed (S210), and the entire rendering area (all the regions of the rendering area) is cleared (S211). And it is confirmed whether or not the rendering instruction is ended, namely, the sending of the rendering instruction 30 from the application program is ended (S212). If the sending is ended (S212: Yes), this bit map generation process (S101) is ended. On the other hand, if the sending is not ended (S212: No), the operation goes to step S201 to repeat the steps S201 to S212 until the rendering instruction 30 sent from the application program is ended.

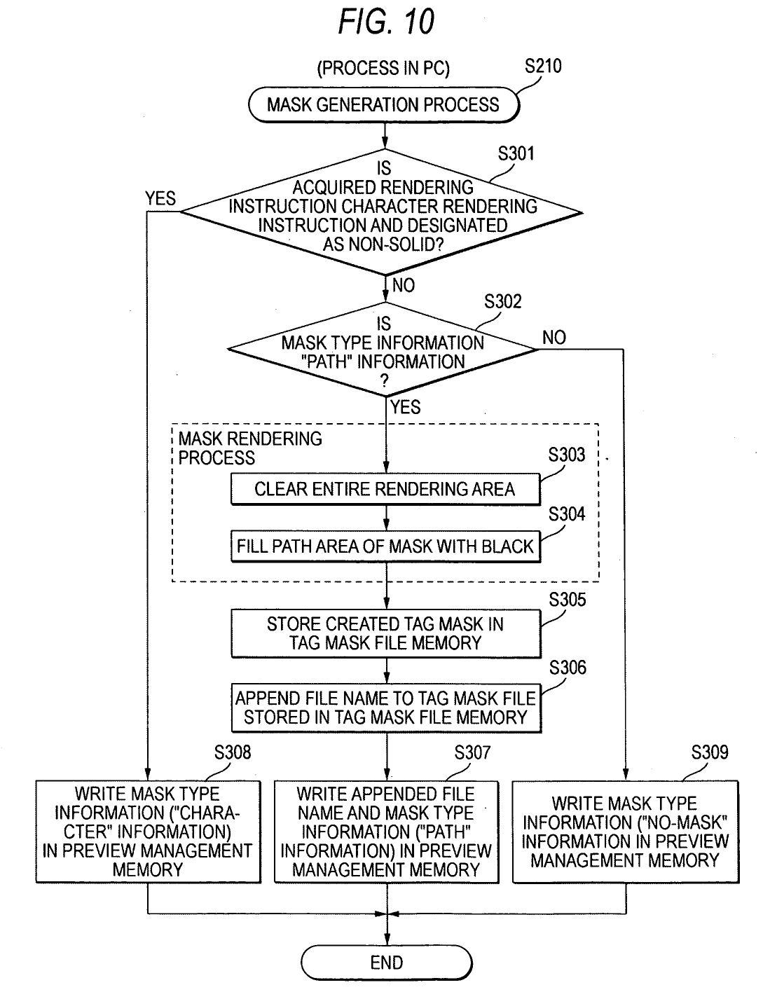

FIG. 10 is a flowchart of the mask generation process (S210) that is performed in the bitmap generation process (S101) of FIG. 9. In this mask generation process (S210), first of all, it is confirmed whether or not the rendering instruction 30 acquired at step S201 is the character rendering instruction and designated as non-solid (S301). If the rendering instruction is not the character rendering instruction or if the rendering instruction is the character rendering instruction but designated as set-solid (not designated as non-solid) (S301: No), it is confirmed whether or not the mask type information 34 included in the rendering instruction 30 is the “path” information (S302).

If the mask type information is the “path” information (S302: Yes), the object rendered by the rendering instruction 30 is the object of non-rectangular graphics, whereby the entire rendering area is cleared (S303) and the path area of the mask is filled in black (S304). The tag mask M2 is created through the mask rendering process at steps S303 and S304.

And the created tag mask M2 is stored as one tag mask file in the tag mask file memory 13c (S305). Further, the file name is given to the tag mask file stored in the tag mask file memory 13c (S306). This file name is the unique file name not overlapping the other file names. Thereafter, the given file name (tag mask file name 47) and the mask type information 44 (“path” information) are written into the preview management memory 13a in association with the rendering area information 45 stored in at step S204 or S205 (S307), and this mask generation process (S210) is ended.

Also, as a result of confirmation at step S301, if the rendering instruction is the character rendering instruction and designated as non-solid (S301: Yes), the mask type information 44 (“character” information) is written into the preview management memory 13a in association with the rendering area information 45 stored at step S204 or S205 (S308), and this mask generation process (S210) is ended.

Moreover, as a result of confirmation at step S302, if the mask type information 34 of the rendering instruction 30 is not the “path” information (S302: No), the object rendered in accordance with the rendering instruction 30 is the rectangular object, whereby the mask type information 44 (“no-mask” information) is written into the preview management memory 13a in association with the rendering area information 45 stored at step S204 or S205 (S309), and this mask generation process (S210) is ended.

FIG. 11 is a flowchart of the preview screen generation process (S102) that is performed in the preview process of FIG. 8. Before performing this preview screen generation process (S102), the bitmapped data of each object displayed in one preview image and its corresponding tag mask M2 are already generated, and stored in the rendering file memory 13b and the tag mask file memory 13c. Also, the preview management memory 13a stores the information regarding each bitmapped data for each object. Therefore, in the preview screen generation process (S102), the bitmapped data of each object or the tag mask M2 is precisely read from the corresponding rendering file or the tag mask file by referring to the preview management memory 13a to form the preview image. That is, since the preview image is formed based on the prestored bitmapped data, the preview image can be displayed promptly on the LCD 16, especially after the edit process is performed.

In this preview screen generation process (S102), first of all, the count value (i) of the object counter 13e is set at 1 (S401). It is confirmed whether or not the count value (i) exceeds the number of objects stored in the preview management memory 13a (S402). If the count value (i) of the object counter 13e exceeds the number of objects (S402: Yes), the rendering (writing into the preview image memory 13d) of all the objects is ended, whereby the image data stored in the preview image memory 13e is outputted to (displayed on) the LCD 16 (S403), and this preview screen generation process (S102) is ended.

Also, as a result of confirmation at step S402, if the count value (i) of the object counter 13e does not exceed the number of objects (S402: No), the rendering of all the objects is not ended, whereby the rendering process for the ith object in the rendering order is performed by referring to the preview management memory 13a (S404). After the rendering process for the ith object is performed, the count value (i) of the object counter 13e is incremented by one (S405), and the operation goes to step S402.

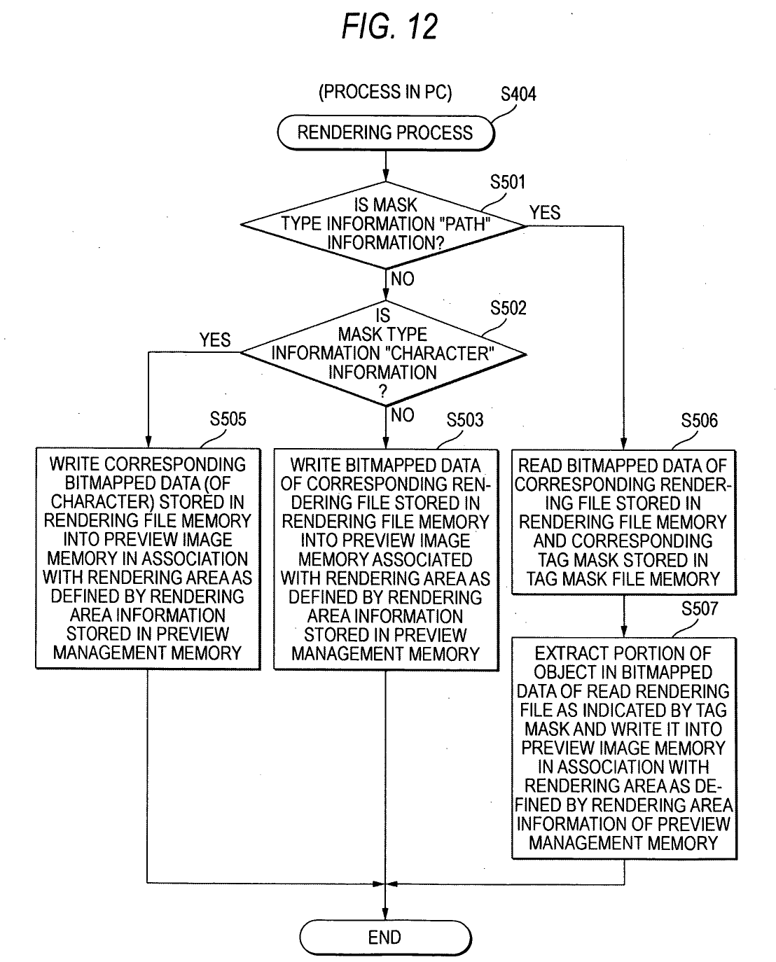

FIG. 12 is a flowchart of the rendering process (S404) for the ith object that is performed in the preview screen generation process (S102) of FIG. 11. This rendering process (S404) involves rendering the bitmapped data of the rendering file by referring to the tag mask M2 to generate the preview image to be actually displayed.

In this rendering process (S404), first of all, it is confirmed whether or not the mask type information 44 stored in the ith rendering order in the preview management memory 13a is the “path” information (S501) If the mask type information is not the “path” information (S501: No), the object is rectangular, whereby it is confirmed whether or not the mask type information 44 is the “character” information to confirm whether or not the rectangular object is the character or the graphics (S502). As a result, if the mask type information 44 is the“character” information (S502: No), the object rendered in the ith order is the rectangular graphics but not the character. Hence, the bitmapped data of the corresponding rendering file stored in the rendering file memory 13b is written into the preview image memory 13d in association with the rendering area as defined by the corresponding rendering area information 45 stored in the preview management memory 13a (S503), and this rendering process (S404) is ended.

On the other hand, as a result of confirmation at step S501, if the mask type information 44 is the “path” information (S501: Yes), the object to be rendered is not rectangular, and the tag mask M2 corresponding to the bitmapped data of the object is stored in the tag mask file memory 13c. Accordingly, the bitmapped data of the corresponding rendering file and the tag mask M2 are read from the rendering file memory 13b and the tag mask file memory 13c, respectively (S506).

And a part of the bitmapped data of the read rendering file, indicated as the object by the tag mask M2, is extracted, and written into the preview image memory 13d in association with the rendering area as defined by the corresponding rendering area information 45 stored in the preview management memory 13a (S507). Thereby, the margin portion of the bitmapped data other than the object is not outputted to the LCD 16 and not displayed.

Also, as a result of confirmation at step S502, if the mask type information 44 is the “character” information (S502: Yes), the bitmapped data of the corresponding rendering file stored in the rendering file memory 13b is written into the preview image memory 13d in association with the rendering area as defined by the corresponding rendering area information 45 stored in the preview management memory 13a (S505).

At step S505, the object is the character and therefore rectangular, but the character and the margin portion other than the character are mixed. However, since the bitmapped data formed of the binary data indicating the display dot and the non-display dot is stored in the rendering file in accordance with the rendering instruction 30, the data is written according to such binary data in the preview image memory 13d, whereby the margin portion other than the character is not displayed on the LCD 16.

Also, if the character is designated as set-solid by the rendering instruction 30, the other portion than the character is designated as fill, and in the generated bitmapped data, the character portion and the other portion than the character are directly represented in the usual bitmapped data, whereby the object can be treated like the rectangular graphics. Therefore, the mask type information 44 is stored as the “no-mask” information in the preview management memory 13a, whereby the operation branches to Yes at step S501.

In the above rendering process (S404), a series of information regarding the dot data stored in the preview management memory 13a are specified by designating the rendering order. Accordingly, the rendering file name 46 of one object is recognized and the corresponding rendering file is selected, and the tag mask M2 is also selected from the tag mask file name 47. Also, the corresponding rendering area information 45 is selected.

If the object is scaled up or down by editing, the rendering area information 45 is changed to define the rendering area scaled up or down from the prestored data. Therefore, the bitmapped data read from the rendering file memory 13b and the tag mask file memory 13c is decompressed or compressed so that the data may be developed in the range as indicated by the rendering area information 45. And the bitmapped data after decompression or compression is written into the preview image memory 13d.

As described above, the printer driver 14a mounted on the PC 10 can generate the bitmapped data of each object to form the preview image, and display the preview image using the generated bitmapped data. Also, if the object is not rectangular, the tag mask M2 for identifying the object portion within the bitmapped data is generated, and only the portion of the object within the bitmapped data can be displayed based on that tag mask M2. Therefore, the preview image after editing can be displayed promptly, and the object can be correctly displayed in the mode to be displayed in which the other object is not made in non-display by the margin portion of the bitmapped data against the operator's intention.

While the invention has been described above based on the aspects, the invention is not limited thereto. Various variations or modifications may be made thereto without departing from the spirit or scope of the invention.

For example, the printer driver 14a generates the bitmapped data by making the rendering based on the rendering instruction 30, but the bitmapped data may be generated by an operation program, and the printer driver 14a may store the bitmapped data already generated by the operation program as the rendering file in the rendering file memory 13b, and generate the tag mask M2 from the bitmapped data stored in the rendering file memory 13b.

While the dot data of each object for the preview image is generated in the bitmapped data format (bitmap format), the generated dot data may be in the other raster graphics format such as a GIF format or a JPEG format.

While the mask M1 is limited to the rectangle and the shape of the object masked by the mask M1 is limited to the rectangle, the mask M1 may take various shapes and the masked object may take various shapes. If the shape of the masked object is not rectangular, the mask type information 34, 44 is set as the “path” information.

If the object is the character or rectangular, the tag mask M2 is not generated, or otherwise the tag mask M2 is generated. Instead, or in addition, the operator may select whether or not to generate the tag mask M2, in which the tag mask M2 is generated for the object designated by the operator. Further, the tag mask M2 is not limited to the bitmapped data, but may be formed in the dot data other than the bitmapped data, or in the data of vector graphics.

While the preview screen generation process (S102) is configured to render all the objects again, if the new edit is made, instead, the rendering process may be performed for only the portion corresponding to the edited object if the new edit is made. In such a case, if the edit is recognized in the preview process (S104: Yes), the preview process is configured to delete only the portion corresponding to the edited object among the data stored in the preview image memory 13d. Thereby, the preview image after editing can be displayed promptly.

The bitmapped data is generated when the first preview image is displayed in the preview process and the preview image is displayed by the bitmapped data. Instead, the preview process maybe configured such that at least for the first preview image, the rendering data rendered from the rendering instruction 30 is written into the preview image memory 13d, and the image generated from the rendering instruction 30 is displayed on the LCD 16 (without generating the bitmapped data).

Since the edit is made by the operation of the operator at will, the edit may not be often performed. The display of the preview image with the bitmapped data is intended to shorten the time taken to redisplay the preview image by avoiding rendering the preview image from the rendering instruction 30 every time when displaying the preview image repeatedly. On the other hand, if the edit is not executed, the preview image can be displayed promptly by simply displaying the rendering data rendered from the rendering instruction 30 on the LCD 16. This is because the process for generating the bitmapped data of the object or the tag mask M2 from the rendered dot data can be omitted. Thus, when the edit is made, the bitmapped data of the object or the tag mask M2 is generated from the rendering data. For the first preview image displayed before the edit is made, the rendering data is outputted to the LCD 16, whereby the entire process for displaying the preview image is made more efficient.

What is claimed is:

1. A print control program product comprising:
software instructions which, when executed on a computer, enables the computer to perform predetermined operations; and
a computer readable medium which stores the software instructions;
the predetermined operations including the steps of:
outputting a print data to a printing apparatus to enable the printing apparatus to print an image corresponding to the print data;
displaying a preview image that visualizes the printing result on a display device before the outputted print data is printed;
editing a rendering object displayed in the preview image based on a change instruction for the preview image displayed on the display device; and
redisplaying the edited preview image,
wherein, before the displaying step, the predetermined operations further include:
storing the image data of the rendering object displayed in the preview image as a dot data in which a range containing at least the rendering object is represented in a dot arrangement;
generating a tag information for distinguishing a portion corresponding to the rendering object within the dot data from the other portion, if the dot data contains a portion other than the rendering object; and
storing the tag information in association with the dot data, and
wherein the redisplaying step includes:
displaying the rendering object after editing based on the dot data; and
extracting and displaying a portion of the rendering object from the dot data in accordance with the associated tag information, if the tag information corresponding to the dot data is stored at the tag information storing step.

2. The print control program product according to claim 1, further comprising:
acquiring a rendering information including at least one of an outside shape information indicating the outside shape of the rendering object, a representation information for representing a form of the rendering object, and a rendering area information indicating a rendering area, the rendering information being the information for defining the rendering object and set for each rendering object,
wherein the displaying step includes rendering the rendering object in accordance with the representation information and the rendering area information of the rendering information acquired at the acquisition step, and
wherein the image data storage step stores the dot data containing the rendering data of the rendering object rendered at the rendering step.

3. The print control program product according to claim 2, further comprising:
judging whether or not to generate the tag information corresponding to the rendering object, based on the rendering information of the rendering object,
wherein the tag information generating step generates the tag information for the dot data, if the tag generation judgement step judges to generate the tag information for the dot data.

4. The print control program product according to claim 3,
wherein the image data storing step includes:
storing the rectangular rendering data directly as the dot data, if the outside shape of the rendering object is rectangular in accordance with the outside shape information; and
storing the dot data in a rectangular range including the rendering data of the rendering object rendered at the rendering step and additionally its peripheral portion, if the outside shape of the rendering object is not rectangular in accordance with the outside shape information, and
wherein the judging step judges to generate the tag information, if the outside shape of the rendering object is not rectangular.

5. The print control program product according to claim 4,
wherein the judging step judges not to generate the tag information, if the outside shape of the rendering object is rectangular.

6. The print control program product according to claim 3,
wherein the judging step judges to generate the tag information, if the rendering information acquired at the acquisition step is not a character rendering information, and
wherein the dot data storing step includes storing the character rendering data rendered at the rendering step directly as the dot data.

7. The print control program product according to claim 6,
wherein the judging step judges not to generate the tag information, if the rendering information is the character rendering information.

8. The print control program product according to claim 6, further comprising:
extracting a common area between the mask area information indicating a mask area contained in a mask information and the rendering area information, if the rendering information has the mask information indicating that at least part of the rendering object is masked,
wherein, if the extracted common area is rectangular, the dot data storing step stores the rendering data of a portion corresponding to the common area as the dot data.

9. The print control program product according to claim 1, further comprising:
a specific information storage step of storing, for each the rendering object, the tag presence information indicating that the tag information corresponding to the dot data is stored, the dot specific information specifying the dot data, and the tag specific information specifying the tag information,
wherein, when the rendering object is redisplayed, the redisplaying step specifies and displays one dot data corresponding to the rendering object with the stored dot specific information, when the rendering object is redisplayed, and
wherein, if the tag presence information is stored corresponding to the dot specific information, the redisplaying step specifies one tag information with the corresponding tag specific information and extracts and displays a portion of the rendering object from the dot data based on the specified tag information.

10. The print control program product according to claim 1,
wherein a rendering order and a rendering area information of the rendering object are changeable based on a change instruction,
wherein the editing step includes editing the rendering object displayed in the preview image by updating the rendering order or the rendering area information based on the change instruction,
wherein the redisplay step includes displaying the corresponding rendering object in the dot data in accordance with the rendering order or the rendering area information after update, and
wherein the initial values of the dot data are held, irrespective of whether or not at least one of the corresponding rendering order and the corresponding rendering area information is updated.
